(19) United States
(12) Patent Application Publication
(10) Pub. No.: US 2017/0151989 A1
(43) Pub. Date: Jun. 1, 2017

(54) Wearable LED warning light a safety device and turn signal lights utility belt

(71) Applicant: Robert W. Daniels, El Paso, TX (US)

(72) Inventor: Robert W. Daniels, El Paso, TX (US)

(21) Appl. No.: 14/954,714

(22) Filed: Nov. 30, 2015

(51) Int. Cl. B62J 6/00; F21V 23/04; F21V 23/02; B62J 6/16

(52) U.S. Cl. CPC B62J 6/005; B62J 6/16; F21V 23/0435; F21V 23/02; B62J 2300/008; F21Y 2101/02

(57) ABSTRACT

The invention is a utility belt used to alert vehicles and pedestrians to the presence of a cyclist through a built-in LED lighting device. Another function of the safety utility belt is to alert vehicles and pedestrians of the direction the cyclist intends to turn by the use of built-in LED turn signal indicators. The utility belt is composed of a shock resistant, water resistant, silicone rubber belt. The electronics associated with this belt are encased within the silicon rubber belt to protect the electronics from shock and weather conditions. The cyclist has complete control over the brightness and alternating frequency or speed of the warning lights. This allows the cyclist to adjust to various traffic conditions. The cyclist can control whether the LED warning lights will be flashing or non-flashing. This adjustment allows the cyclist to use the non-flashing lights when cycling with other cyclists, therefore not interfering with the vision of other cyclists. The cyclist also has the ability to adjust to daylight versus nighttime lighting conditions.

### CROSS REFERENCES TO RELATED APPLICATIONS

Not applicable

### STATEMENT REGARDING FEDERALLY SPONSORED RESEARCH OR DEVELOPMENT

This invention was not made with government support.

### BACKGROUND OF THE INVENTION

The invention relates to the general field of bicycle safety lighting.

The Wearable LED (Light-Emitting Diode) Warning Light, or The Wearable for short, was invented primarily as a safety light device to be worn much like a belt by bicyclists. The purpose of The Wearable is for cyclists to alert motorists, other cyclists, pedestrians, etc. of the cyclists' presence while they are riding. Although there are various safety devices for bicyclists currently being sold, what sets the Wearable apart from other safety light devices and bicycle safety light devices, is the fact that most of the aforementioned products are designed for illuminating the bicycle and/or the cyclist only during nighttime hours; the Wearable not only illuminates the cyclist during nighttime hours, but it also has a unique set of LED lights that will illuminate riders during the oft forgotten daytime hours as well. This feature is accomplished by utilizing time frequency programming of alternating flashing LED lights along with the varying intensity of the brightness of the LEDs for illumination. The lighting device is designed to create a 360 degree view of the cyclist that ensures riders are easily visible and recognizable from all directions. Another unique component of The Wearable is it allows the cyclist to control both the intensity and frequency of the lights on the belt when needed to compensate for the difference in the light between nighttime and daytime hours. This device is described in greater detail below.

### SUMMARY OF THE INVENTION

The Wearable is designed much like a clothes belt that a cyclist would wear during their bicycle rides. The Wearable has two sets of flashing LED warning lights to alert oncoming traffic of the cyclists' presence: one on the back of the belt, the other set on the front (all described in detail below). The frequency (timing) and brightness and of the lights are controlled independently by the cyclist by using a control panel, which is attach to the belt (also detailed below).

The wearable safety belt integrates warning lights with turn signal lights to increase both the cyclist's safety and visibility; both sets of lights are powered by a 12 volt battery pack. Most bicycle safety lights are powered by 9 volts or less. The 12 volt battery pack will increase the visibility of the bicycle safety lights during daylight hours. The National Highway Traffic Safety Administration (NHTSA) reported most bicycle accidents occurred during daylight hours as reported in TRAFFIC SAFETY FACTS. 2012 Data Report (U.S. Department of Transportation, National Highway Traffic Safety Administration). This report cited 69% of pedalcyclists fatalities occurred during daylight hours. The report also indicated majority of bicycle and car collisions were due to lack of visibility of the bicyclists.

The warning lights on one side of the belt will flash in a synchronized pattern, alternating with the LED lights on the opposite side of the belt. This will create a 360° viewable warning system. The user will have control of the light intensity (brightness) and the flashing frequency.

The wearable belt will also contain four turn signals. Each directional signal will have two LED components for each side of the bicycle jersey. Each directional indicator will have a front and rear LED component that will flash in the synchronized pattern. The right and left directional indicators will flash independently and will be controlled by the radiofrequency remote control unit attached to the handlebar. The exposed portion of the wearable belt will be waterproof, and the batteries will be charged from a battery charger.

### BRIEF DESCRIPTION OF THE DRAWINGS

FIG. 1 is a diagrammatic representation of wearable safety bicycle belt in a plan view.

FIG. 2 is a diagrammatic representation of the wearable safety bicycle belt in operational position (front) with control panel, LED warning and turn signal lights.

FIG. 3 is a diagrammatic representation of the wearable safety bicycle belt in operational position (rear) with LED warning and turn signal lights.

FIG. 4 is a diagrammatic representation of the wearable safety bicycle belt in a plan view (top) illustrating the positions of the control panel, LED warning and turn signal lights.

FIG. 5 is a diagrammatic representation in a plan view (top) illustrating the control panel with frequency, brightness and on/off pushbutton switches.

FIG. 6 is a flowchart illustrating the functions of each pushbutton switch associated with the control panel.

FIG. 7 is a diagrammatic representation in a plan view (top) illustrating the cyclists' control for the brightness of the warning lights.

FIG. 8 is a diagrammatic representation in a plan view (top) illustrating the alteration or flashing of the warning lights between the right side warning lights and the left side warning lights.

FIG. 9 is a diagrammatic representation in a side view illustrating the location of the battery packs, PCB compartment, and access port for charging batteries.

FIG. 10 is a diagrammatic representation in a side views illustrating access port inlet and plug components.

FIG. 11 is a diagrammatic representation illustrating the RF signal transmitting from the pushbutton control transmitter (turn signal controller) on the handlebars to the RF receiver in the rear of the wearable safety belt.

FIG. 12 is a diagrammatic representation illustrating various positions of the pushbutton turn signal controller.

FIG. 13 is a diagrammatic representation illustrating operational position of the wearable safety belt on a cyclist.

FIG. 14 is a diagrammatic representation illustrating how the Wearable is typically positioned on a cyclist.

FIG. 15 is a diagrammatic representation illustrating the 360° light coverage created by the four warning lights. Each warning light has 120° illumination angle.

FIG. 16 is a diagrammatic representation illustrating the 360° light coverage created by the four turn signal lights. Each warning light has 120° illumination angle.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The device has two primary safety features, warning lights, described herein, and turn signals. The first safety feature is a series of flashing LED warning lights. There are a total of four warning lights, two on the left sign and two on the right, with each individual light containing a LED light panel for maximum brightness. The belt is worn on the rider's low back, allowing one set of lights to be viewed on the rider's back, and the second set of lights to be viewed on the rider's front side.

The second safety feature is a set of LED turn signals, one set on the right side of the belt, the other on the left. Both the aforementioned LED warning lights and turn signals are embedded into the belt, through an encapsulation molding process. Like the warning lights, when the belt is worn the turn signals are also visible on both the rider's back and front sides.

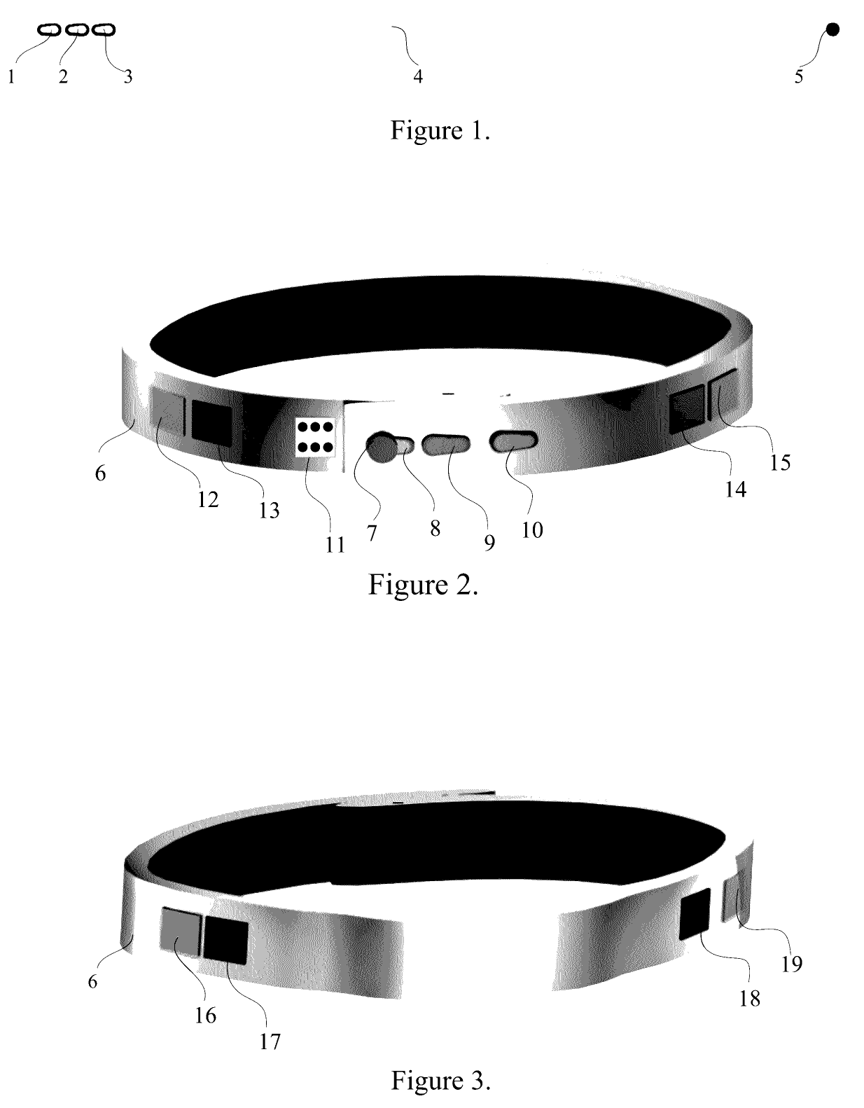

The belt itself is lightweight made of rubberized silicone, is easily removed and comfortable for the cyclist to wear. The warning and turn signal lights are sleekly encased within the belt; the lights do not protrude nor do they create an annoyance or hinder the cyclists' ability to ride. As seen in FIG. 1, much like an everyday belt the Wearable 1 is worn on top of the riders' clothing by latching the button holes 2, 3 and 4 to the accompanying latching button 5, this eliminates any need for clothing loops to be attached to the cyclist. The Wearable comes with latching button holes, so the belt may be worn by riders of various sizes.

FIG. 2 is a graphic representation of the bicycle safety belt in an operating position during use by bicycle riders. The belt 6 is secured around the waist of a bicycle rider by latching the single button 7 with one of three latching holes 8, 9, and 10. FIG. 2 also shows the front side of the bicycle safety belt. From left to right, this representation shows the control panel 11, front right side turn signal light 12, front right side warning light 13, front left side warning light 14, and the front left side turn signal light 15.

Rear side of the belt 6 is shown in FIG. 3. In this view the rear left turn signal light 16, rear left warning light 17, rear right warning light 18 and the rear right turn signal light 19 can be seen.

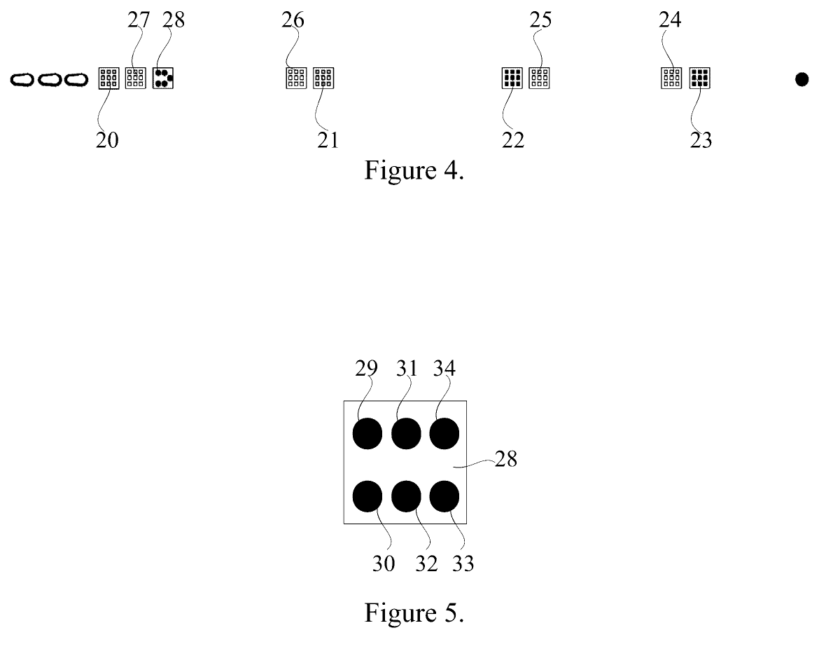

FIG. 4 is a plan view of the exterior of the wearable safety belt. In this figure all lights and the control panel are depicted. The LED panels for the warning light system are the left front LED warning light 20, left rear LED warning light 21, the right rear LED warning light 22 and the right front LED warning light 23. The four turn signals are as follows, left front LED turn signal light 24, left rear LED turn signal 25, the right rear LED turn signal 26 and the right front LED turn signal 27. Also depicted in this view is the control panel 28. An enlarged view of the control panel can be seen in FIG. 5.

The control panel is a rubberized molded material. The control panel will contain six rubberized pushbutton control switches. One push button toggle switch will be used as the on/off power switch. Another push button switch will control whether the lights are in flashing or non-flashing modes. Two sets of momentary switches will be used as the increase/decrease frequency control switches. The last two sets of switches will be momentary switches to control the increase/decrease of the brightness.

The panel will control the changes in frequency and brightness; the panel will also contain an on/off switch to control the power of all circuitry within the belt. Unless specified, the wires used in this device will be 22 gauge single extruded copper wire with plastic insulated coating.

A second single momentary switch is connected to the inputs of the digital potentiometer which controls the decreasing of resistance and thus will increase the brightness of the warning lights.

The control panel operates the brightness, frequency (speed) of the alternating warning lights and the on off operation of the belt. The belt is designed to have a variable light intensity (brightness) and this light intensity is controlled by a pushbutton for increasing the brightness 29 and a second pushbutton for decreasing the brightness 30.

The second set of controls on the control panel is for increasing or decreasing the speed of the alternation of the warning lights. The pushbutton for increasing the speed of the altering of the warning lights to the maximum speed can be found at pushbutton 31. The alteration of the warning lights can be decreased to a slow enough speed where the warning lights will show a slow steady alternating light pattern. The decrease in frequency can be controlled by depressing pushbutton 32.

One unique aspect of this invention is the ability to control the intensity or brightness of the warning lights. The two brightness buttons on the control panel 28 and 29 can vary the brightness intensity from the warning lights completely off at the lowest setting on button 30 (decrease in light intensity) to the maximum brightness of the power and circuit system by depressing button 29.

Another pushbutton 33 on the control panel is the on/off switch is pushbutton switch. The last pushbutton 34 on the control panel controls whether the warning lights are operating in a flashing versus non-flashing mode. It is important for the cyclist to have control whether the warning lights operate in a flashing or non-flashing mode. The intent of this warning light system is to let the cyclist control the lighting situations depending on varying circumstances. An example of a circumstance where the cyclist may want to have non-flashing warning lights would be if a group of cyclists riding together were all wearing the Wearable. A flashing mode would interfere with any cyclist traveling behind the cyclists with the flashing warning lights. The front cyclists have the ability to turn off the flashing mode but still retain the safety from non-flashing, warning lights.

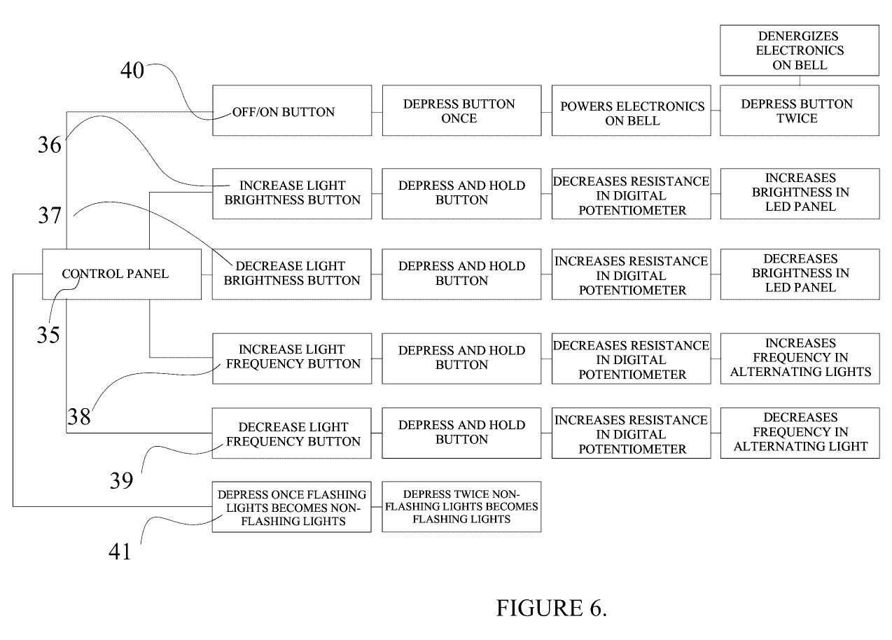

FIG. 6 is a flowchart depicting the operations of each pushbutton associated with the control panel 35. The operation of the five pushbuttons associated with the control panel is expressed in this flowchart. 36 and 37 are for the operation of decreasing and increasing the brightness of the warning lights. 38 and 39 is decreasing and increasing the frequency of the alternating lights. 40 is the off/on pushbutton. 41 is the pushbutton for controlling whether the warning lights are in flashing or non-flashing modes.

The brightness and the frequency of the harmonic oscillation can be controlled to be adjusted by the rider to change for various road, lighting and weather conditions (described in depth below). The timing sequence can be changed within the digital timer and digital decoder to vary the harmonic oscillation in the light pattern of the warning lights. The harmonic oscillation is a fluctuation in the sinusoidal wavelength pattern. Without changes to the frequency the wave pattern would oscillate in a continuous repetitious pattern. The frequency control on the control panel will allow the rider to increase or decrease the number of times lights will alternate (turn on and off right and left side warning lights) in a given time period. If the cyclist is riding with a group of other cyclists, the rider has the ability to turn the frequency of the lights down to a very slow alternating sequence. In turn, if the cyclist is bicycling in heavy traffic, they can increase the alternating lighting rate. The ability to control one's own illumination allows the bicycle rider to use their judgment and gives them complete control over what they feel is the best illumination for their ride during various and changing light and weather conditions. The brightness controller is a variable controller allowing the bicycle rider to adjust from low to full brightness.

Lights have been programmed (technical description of light programming is discussed in further detail below) to alert the oncoming vehicles of the rider's presence; this system creates maximum recognition of the cyclist without lights that would visually interfere with vehicles' driver views.

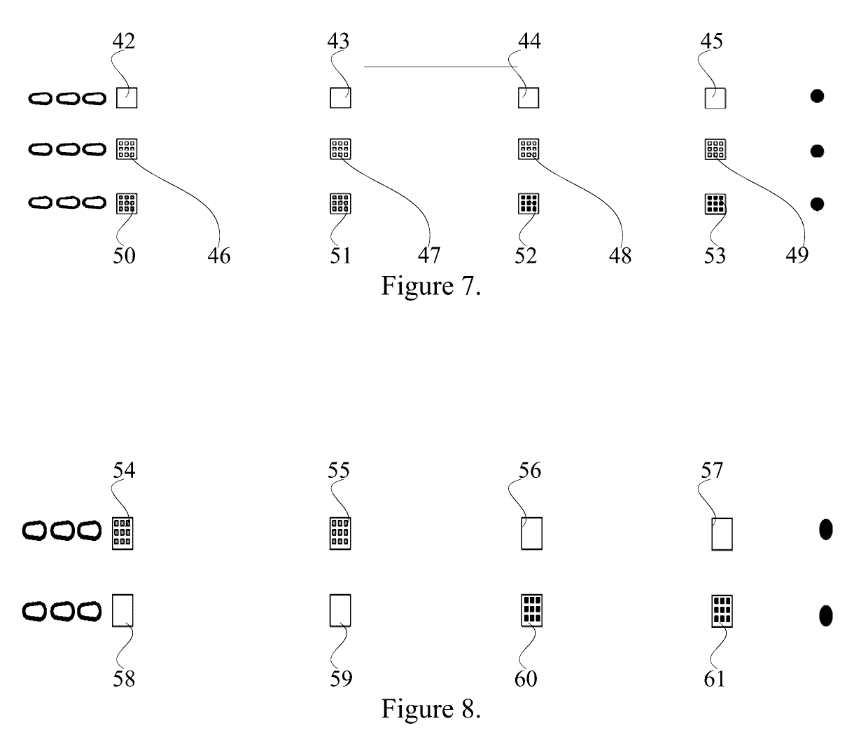

FIG. 7 graphically represents the ability of the system to change from low to high brightness of the warning lights. At the lowest brightness setting warning lights left front 42, left rear 43, right rear 44, and right front 45 show the lights to be off. 46, 47, 48 and 49 show the warning lights to be set at a medium light intensity. Lights 50, 51, 52 and 53 show the warning LEDs at the maximum light intensity.

The two frequency pushbuttons are connected to digital potentiometers to slow down or speed up the alternating pattern of the warning LEDs. The rubberized pushbutton switch for controlling the decrease in frequency is a single momentary switch connected to a digital potentiometer. The digital potentiometer will receive the signal from the pushbutton momentary switch and convert the signal to a digital format. A digital potentiometer will operate the same way normal potentiometers operate; both the digital and normal potentiometer has the ability to control the variable resistor function within a potentiometer. The main difference between these two types of potentiometers is in the fact that a normal potentiometer has a mechanical function (a physical contact) to control the variable resistor, whereas the digital potentiometer uses varying digital signals to control the variable resistor. The potentiometer divides the variable resistor into incremental steps. Each step represents a different resistance range from low to high or high to low, and every step of the ladder is a different electronic switch. Only one electronic switch can be closed or activated in any giving time period. The closed switch determines the position of the wiper within the potentiometer's resistance ratio. The digital potentiometer has 64 steps to control the resistance of the Decade Counter with 10 Decoded Outputs.

The warning lights have a predetermined flashing pattern as set by the timing circuit. This predetermined flashing pattern will alternate between the right side warning lights and the left side warning lights. The increase and decrease frequency pushbuttons 31 and 32, controls the alternating speed between the right side warning lights and the left side warning lights. Therefore there are two lighting patterns for the warning lights. First is the lighting pattern as determined by the timing circuit. An example of this lighting pattern can be the warning lights on the right side flash in a pre-programmed pattern with the left side warning lights off. The above is an example of one light timing pattern; however this invention can vary the lighting pattern in numerous ways and should not be limited by the above example. The two lighting patterns will be the predetermined lighting pattern as defined in the timing circuit and the alteration between the right side warning lights and the left side warning lights. This is graphically depicted in FIG. 8 where the left side warning lights 54 and 55 would be blinking when the right side warning lights 56 and 57 are off. In turn, the graphic representation shows the left side warning lights 58 and 59 in the off position when the right side warning lights 60 and 61 are in the predetermined lighting pattern as set by the timing circuit.

The brightness is controlled in a similar fashion to the frequency. Two momentary switches 29 and 30 sends a signal to a second digital potentiometer. The function of this digital potentiometer is to control the power to the warning light circuit. Depressing the pushbutton 29 will increase the resistance of the power within the circuit and therefore will result in a decrease in brightness. In turn the brightness can be increased by depressing pushbutton 28.

Any cyclist who has taken a long ride knows that ambient lighting conditions do not only change from day to night, but also throughout daylight hours. Without brightness adjustment the lighting pattern may be too dim to illuminate the rider during the daytime or too bright at night, thus causing a distraction to oncoming vehicles, and even to the cyclist themselves. By using the brightness control the cyclist has the independent ability to adapt to various cycling conditions throughout the entire day.

When the rider wears the belt they have two sets of alternating warning lights (rear and front). The front set of warning lights on The Wearable serve two purposes. First, the front lights are visible to the cyclist as well as to oncoming traffic facing the cyclist head on. The front set of LED warning lights, like the back set are also LED light panels. The front set of warning lights are positioned to be visible by the rider, however the rider does not have a direct view of the lights. This is necessary to ensure that the front area of the cyclist is illuminated for oncoming traffic, but does not interfere with the cyclist's vision or perceptions. Pairs of warning lights may either be the same color as the other alternating light or each LED light can be a different color. The cyclist will have a choice of lighting colors (said color choices would not interfere with any particular federal, state or municipal emergency light laws) before they purchase the product. Both the rear and front sets of LED warning lights will be located at the center portion of the rider's back or stomach respectively. The warning lights are located within a soft rubberized silicone belt to provide the maximum comfort, and the silicone has the durability rating to ensure that the electronics (printed circuit board, battery, wiring and lights) are protected from battering associated with a bicycle riding and outdoor field conditions. This means that the writer will be illuminated in a 360° pattern. The illumination for all directions is also set of the elevation to allow a person riding in an average vehicle to have a line of sight view of the wearable safety warning belt. The ability to control the brightness and frequency of the alternating flashing lights along with the 360° illumination makes this invention truly unique over any prior art.

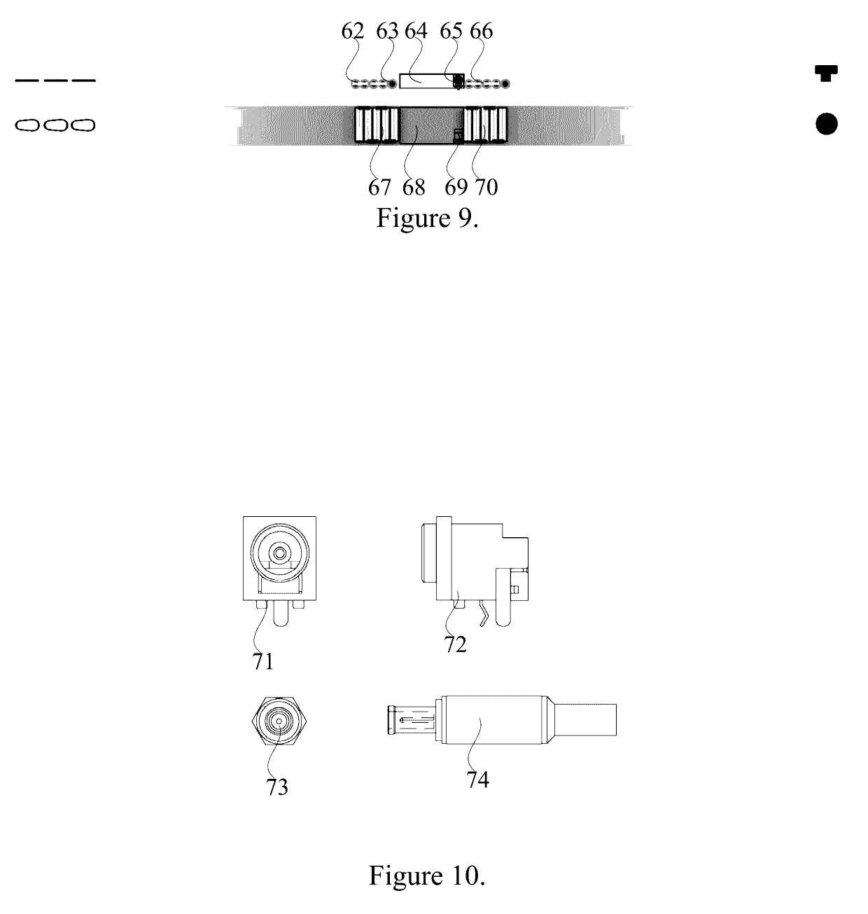

The on/off toggle switch 33 will be placed between the 12 Volt battery and the PCB to control the power to the timing circuits. The normally open switch (0 Volt) will activate the circuits to a (12 Volt, closed) energize state. The power for the 12 Volt source is supplied by 2-6 Volt battery packs in series and can be viewed in FIG. 9, horizontal view, left side battery pack 62 and right side battery pack 66. Each battery in the pack is connected by a battery bar 63. 64 is the PCB storage case and 65 is the battery recharge connection port. The battery packs can be viewed in the vertical position, left side battery pack 67 and right side battery pack 70. 68 is the vertical view of the PCB storage compartment and 69 is the vertical view of the recharge access port. This battery recharge access port can be viewed in detail in FIG. 10.

The battery packs and the recharger will be connected by 20 gauge copper wire. An access port will be located within the PCB area. This will allow for a quick disconnection/reconnection between the power source and the battery packs. The access port will be an EIAJ-4 input jack, see FIG. 10. This jack will be wired to the two battery packs. An EIAJ-4 output plug (Concentric Barrel Plug) will be wired to the power source. The EIAJ standard requires that these plugs are always wired with the center pin as positive (+) polarity. In FIG. 10 the input jack can be viewed in two different positions 71 and 72. The output jack can also be viewed in positions 73 and 74.

The access port for the battery recharger cable will have an external cover to make the access port water resistant. The entire belt will be water resistant as well, to allow for riders to wear the belt even during times of inclement weather. The encapsulation of the LED lights not only protects the lights from water, but will also protect electronic components from shock damage in case the belt is dropped or mishandled. The rubberized silicon belt is durable and flexible, which allows for the belt to be lightweight with a slender structure. The silicone belt has been designed to ensure that it will stay in place during the normal stress of bicycling activities; further the belt's lightweight structure allows riders to wear the belt comfortably and without any restrictions in their movements during their ride. The belt has been designed to be adjustable in waist size to allow for the rider to wear the belt on top of a bicycle jersey, lightweight clothing or lightweight jackets. The LED warning lights and turn signals encased in a silicone belt is unique to any known prior art.

The lights and PCB will be powered by 10 AAA 1.2 volt NiMH Batteries or a 12 volt battery pack (10 Cells Pack). The batteries will be arranged into two-5 battery packs, see FIG. 9. Each battery pack will be located on either side of the PCB. The 5 batteries per battery pack will be arranged in a serial connection pattern to create an increase in voltage per battery pack to 6 volts. The two packs will also have serial connection arrangements to increase the voltage to 12 volts. The AAA battery will have a 1,000 mAh capacity. The AAA batteries will be charged by a 12 volt Smart Charger (to be purchased, but inventor reserves the option to change vendors has technology advances) with automatic voltage detection and temperature sensor to protect battery pack from overheating. The Smart Charger uses pulse and negative pulse technology to avoid battery overheating during fast charging.

The NiMH batteries were selected for safety considerations. A NiMH battery has properties that reduce the probability of overheating and decrease recharging requirements versus using lithium-ion or lithium polymer batteries (LiPo).

To activate the warning lights, the on/off switch is depressed to open the 12 V battery circuit. The 12 V signal from the battery is converted into a 5 V signal and is sent to a digital timer. After the signal is processed through the digital timer, the signal is further processed through a decade counter. The signal is conditioned after the decade counter to send the 5 V timing signal to a transistor amplifier. The 12 volt amplified signal is sent to the warning lights.

Another component of this invention is a remote control, radiofrequency (RF), pushbutton transmitter. The transmitter is encased in a plastic injection molded cover with two rubber covered pushbuttons. This transmitter can be attached readily to the left handlebar of the bicycle by a clamp.

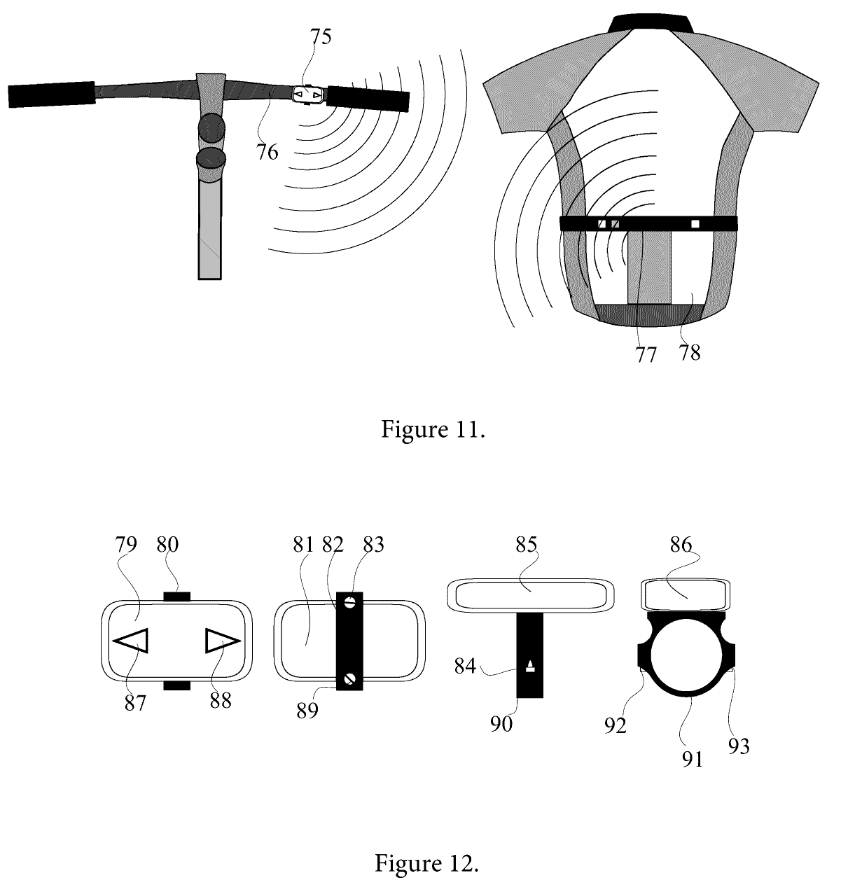

In FIG. 11, the turn signal transmitter 75 is located on the handlebars 76 and is secured using a two-piece clamp, and the clamp is secured to the handlebars by two machine threaded screws.

The turn signals pushbutton switches are attached to the handlebars and are located at a close proximity to the cyclist's reach. The turn signal's waterproof momentary pushbutton switches are connected to a two channel radiofrequency transmitter. The frequency of the radiofrequency transmitter is set to a frequency that will not interfere with other radiofrequency receivers. The radiofrequency transmitter has not been designed by the inventor but rather purchased. However, this design does incorporate a unique technique to use the two channel radiofrequency transmitter to transmit a signal to a two channel radiofrequency receiver 77 located within the printed circuit board. The printed circuit board and battery are stored in an enclosed compartment located and encased in the rear of the belt. The choice to use radiofrequency rather than infrared signals was based on the location of the receiver. Since the receiver is located in the rear of the belt and is not in a line of sight, infrared would have not been applicable for this type of operation. The radiofrequency receiver will control whether the output of the receiver is either energized or de-energized. The printed circuit board's electronic components has a maximum rating at 5 V and therefore the circuit operates at a 5 V load. The normal condition will be the turn signal in the off condition. When the radiofrequency transmitter transmits a signal with the same frequency as the receiver, the receiver's output will go from a deactivated state (0 V) to an activated state (5 V). This activated state will initiate a digital timer to start an electronically programmed sequence. The bicycle cycling jersey 78 helps identify the approximate location where the safety belt and radiofrequency receiver will be located.

The radiofrequency signal is converted into an electronic signal which is sent to a MOSFET transistor switch. The switch activates a digital timer with a predetermined flashing frequency, not controlled by the cyclist. The alternating signal is amplified to a 12 V signal which activates the turn signal lights. Before the timer sequence can be sent to the turn signal LEDs the electronic current must be amplified from 5 V to 12 V. This is accomplished by using a MOSFET transistor. After the timer sequence current is amplified, the current is routed to the correct LEDs.

FIG. 11 simulates the RF signal sent from the RF transmitter to the RF receiver. This will allow the cyclist to notify their indication to turn for both oncoming and rear traffic. The left side of LED turn signal light panels operates in a similar situation as the right side LED lights. There is one pushbutton control located on the handlebar mounted controller for the right side and a second pushbutton control for the left side. This allows the right turn signal to be activated independently from the left turn signal. All four rear, front, right and left sided turn signals will be the same color. The number of individuals LEDs on the rear panels will be the same as the number individual LEDs on the front panels. The intensity and frequency of the turn signals cannot be controlled by the bicycle rider. The design is to have the turn signals at maximum brightness for both daytime and nighttime hours. As with any other moving vehicle the intention is to activate the turn signal long enough to notify vehicles of the cyclist intention to turn a specific direction. The turn signals are not intended to stay on continuously. The oscillation frequency is a simple on/off pattern or a simple flashing pattern found with most vehicles. The light intensity from the front turn signal LED panels will be adequate to notify the oncoming traffic of the bicycle rider's turning intentions. The front turn signal light panels have been located where the cyclist is aware of the lights flashing without interfering with the cyclist's concentration.

Each time the turn signal pushbutton is activated a radio frequency signal is sent to the printed circuit board to either activate or deactivate a turn signal circuit. A radiofrequency receiver operating at the same hertz as the transmitter acts as a switching control device. The right-handed button on the remote control activates an electronic switch to activate the timer for a right directional turn signal circuit. The right side turn signals consist of both front and rear sets of LEDs; this allows both the approaching traffic from either direction along with approaching perpendicular traffic to be notified which direction the cyclist intends to turn. The left-handed button on the remote control activates a similar but separate circuit to illuminate flashing front and rear left-sided LEDs.

FIG. 12 shows the housing for the two channel radiofrequency transmitter. 79 is the top view of the RF casing. 80 is the two-part clamp that will secure the RF transmitter to the handlebars. 81 is the bottom view of the RF transmitter housing. 82 is a bottom view of the clamp and 83 is a view of one of the screws which will secure the clamp to the handlebars. 84 is another view of the screw securing the clamp. 85 is a side view of the RF transmitter housing and clamp. 86 is a second side view of the RF housing and clamp at a 90° turn to the view in 85. 87 is the left pushbutton to activate the left turn signals and 88 is the right pushbutton to activate the right turn signals. 89 is another screw for securing the clamp. 90 and 91 are 90° offset views of the clamp. 92 and 93 are the securing screws for the clamp.

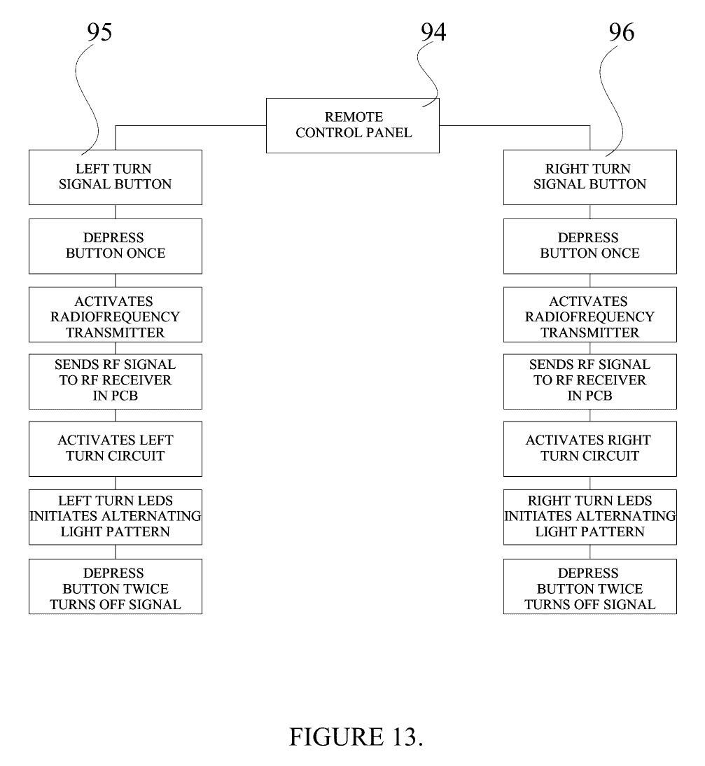

FIG. 13 is a flowchart demonstrating the operational conditions for the remote control panel 94. The flowchart is further subdivided into the operations of the left turn signal button 95 and the right turn signal button 96.

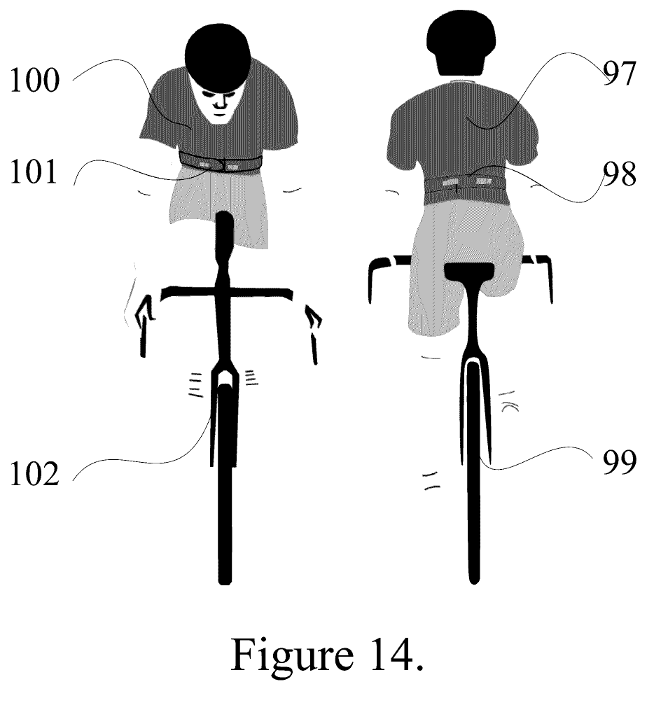

FIG. 14 demonstrates how the belt will be positioned on a typical cyclist riding a bicycle. To further understand the positioning of the belt, a front and rear view of the rider wearing the safety belt can be observed in this figure. The safety belt can be worn over bicycle jerseys, most kinds of shirts and light jackets. Additional latching loops will make it possible for a rider to have a heavy jacket while on the bicycle. 97 is the view of the back of the rider, 98 is the wearable safety belt and 99 is the view of the back of the bicycle. 100 is the front of the rider, 101 is the view of the front of the safety belt and 102 is the view of the front of the bicycle.

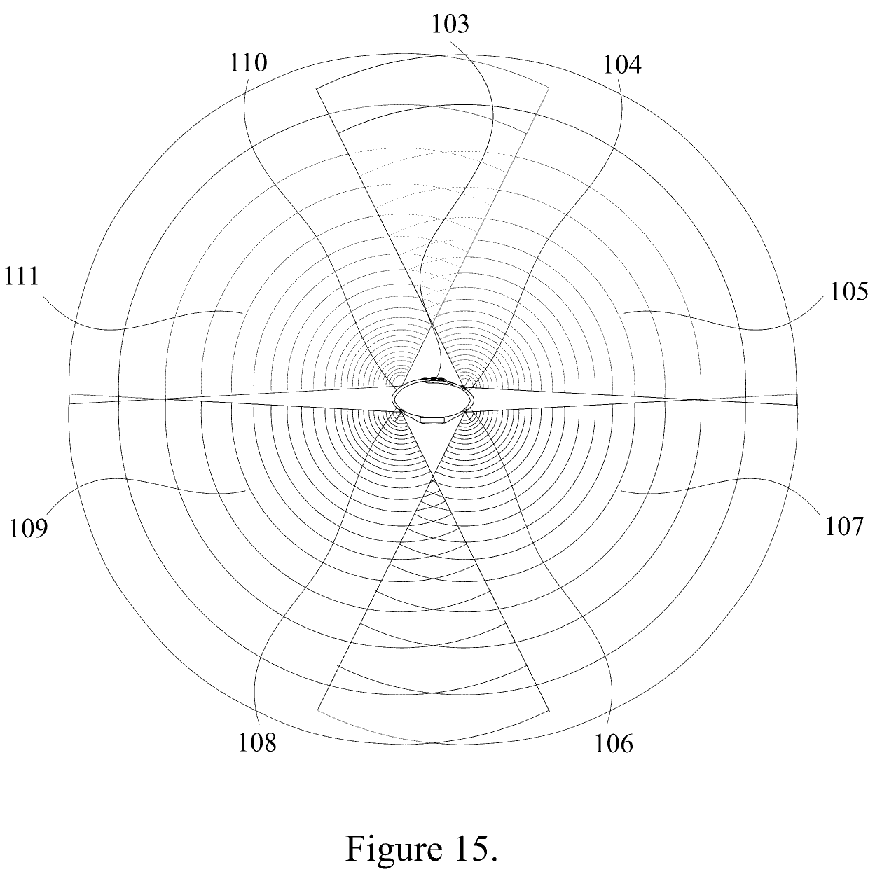

To ensure that the warning lights and the turn signal lights have a 360° field of illumination, LED light panels with a 120° illumination angle were chosen for the wearable safety belt. FIG. 15 demonstrates the position of the four warning lights creating a 360° field of illumination. Within a few feet of the wearable safety belt, the adjacent safety warning lights' 120° illumination angle has a intersect point where the two adjacent warning lights field of illumination overlap. The area beyond the intercept points creates a 360° field of illumination. The wearable safety belt 103 has four warning lights specifically position to create this 360° view. 104 is the position of the right front warning light and 105 represents the 120° field of illumination for 104. 106 is the position of the right rear warning light and 107 is the 120° angle of illumination. 108 is the position of the left rear warning light and 109 is the 120° angle of illumination. 110 is the position of the left front warning light and 111 is the 120° angle of illumination.

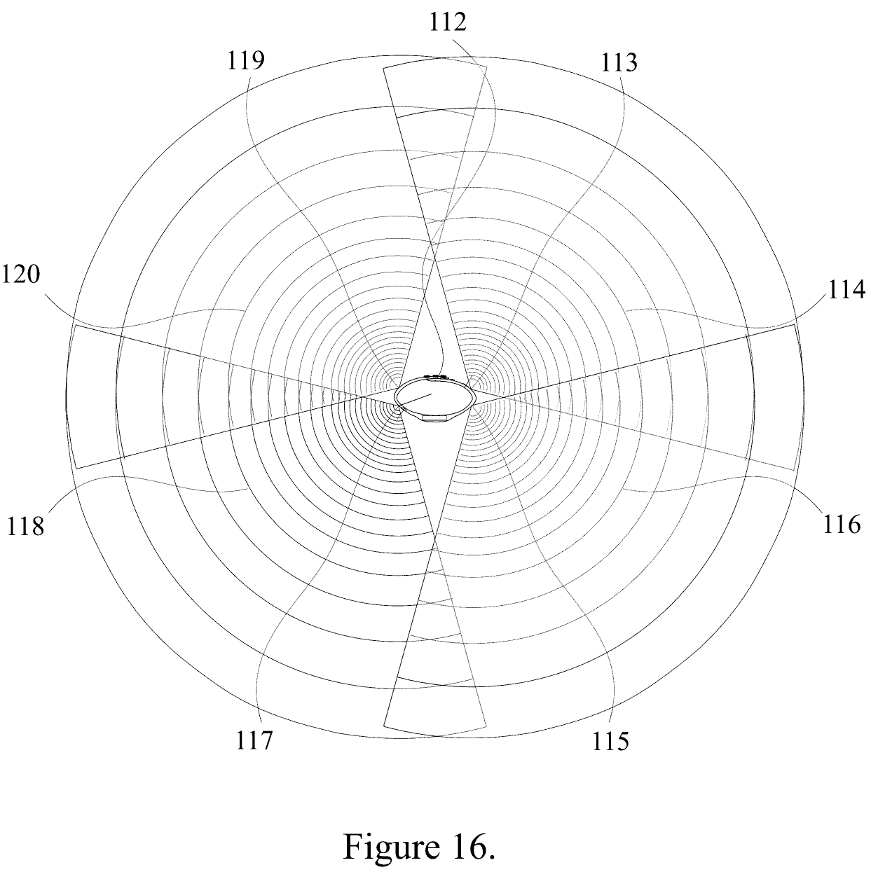

FIG. 16 illustrates the 360° illumination coverage of the turn signal lights. 112 is the wearable safety belt. 113 is the position of the right front turn signal light and 114 is the 120° angle of illumination. 115 is the position of the right rear turn signal light and 116 is the 120° angle of illumination. 117 is the position of the left rear turn signal light and 118 is the 120° angle of illumination. 119 is the position of the left front turn signal light and 120 is the 120° angle of illumination.

What is claimed is:

1. A device designed for safety purposes to be worn around a user's waist in order to illuminate its user; the device comprised of three separate tools: an electronic system of warning-safety lights; a lightweight, rubberized silicone and partially water resistant belt; and a separate directional turn signal indicator, to form one functional device.

2. The electronic system described in claim 1, comprised of 2 sets of right and left warning LEDs lights (light-emitting diodes) with two sets of right and left indicator LEDs lights. Each set of the warning and turn signal indicator lights has a front and rear component positioned on the belt.

3. The electronic system in claim 1, whereby the electronic system is encapsulated within the belt.

4. The electronic system in claim 1, attaches to the belt in claim 1, through a self-contained system of latchable buttons, eliminating the need for secondary attachments.

5. The device in claim 1, wherein the belt creates a 360 degree view of the user, ensures multi-directional visibility and ease of recognition by motorists, pedestrians, and cyclists.

6. The device in claim 1, powered by a 12 V battery system to generate the illumination for daylight hours.

7. The electronic system in claim 1, comprised of LED lights which is operated by the user, through a separate radiofrequency remote control located on the handlebars to activate the turn signals on the belt referenced herein these claims below, and the control panel located on the belt allows the user to adjust brightness and frequency for daytime or nighttime natural lighting conditions.

8. The device in claim 1, operated by a control panel has six independent functions for controlling the on/off of the lighting system, decreasing the frequency of the alternating lights, increasing the frequency of the alternating lights, decreasing the brightness of the warning lights and increasing the brightness of the warning lights. Controlling whether the warning lights are in flashing or non-flashing modes.

9. The electronic system and indicator, both referenced in claim 1, operational by a digital potentiometers which allows the user to control the frequency or speed of the alternating flashing LED lights attached to the belt and controlling the brightness of the warning lights.
